(19) United States
(12) Patent Application Publication
(10) Pub. No.: US 2018/0367647 A1
(43) Pub. Date: Dec. 20, 2018

(54) WIRELESS COMMUNICATION MODULE BASED CLOUD ACCESS METHOD AND SYSTEM

(71) Applicant: MIDEA GROUP CO., LTD., Foshan (CN)

(72) Inventors: Wei Zou, Foshan (CN); Jun Yang, Foshan (CN); Fuxin Liu, Foshan (CN); Zihang Zhou, Foshan (CN); Xiaodong Wu, Foshan (CN)

(21) Appl. No.: 16/008,052

(22) Filed: Jun. 14, 2018

Related U.S. Application Data
(63) Continuation of application No. PCT/CN2015/097741, filed on Dec. 17, 2015.

(30) Foreign Application Priority Data
Dec. 14, 2015 (CN) 201510932085.1

(51) Int. Cl. H04L 29/06; H04W 28/14; H04L 29/08

(52) U.S. Cl. CPC H04L 69/08; H04W 28/14; H04W 84/12; H04L 67/32; H04L 29/08756

(57) ABSTRACT

The disclosure provides a wireless communication device based cloud access method and system. The wireless communication device based cloud access method comprises: the wireless communication device receiving messages of a first type sent by cloud servers and obtaining type information of the cloud servers, and the wireless communication device is connected to a plurality of cloud servers; the wireless communication device calling a corresponding transition protocol according to the type information of the cloud servers; and the wireless communication device converting the messages of the first type to messages of a second type according to the transition protocol and sending the messages of the second type to the corresponding household appliance. The invention can realize the connection of the household appliance with the corresponding cloud server, realize the access of the household appliance to the plurality of cloud servers, and can effectively enhance the wireless communication device based cloud access effect.

### CROSS-REFERENCE TO RELATED APPLICATION

This application is a continuation of International Application PCT/CN2015/097741, filed Dec. 17, 2105, which claims priority to and benefits of Chinese Patent Applications Serial No. 201510932085.1, filed with the State Intellectual Property Office of P. R. China on Dec. 14, 2015, the entire contents of which are incorporated herein by reference.

### FIELD

The present disclosure relates to the field of communication technology, and more particularly relates to a cloud access method based on a wireless communication device.

### BACKGROUND

In recent years, as a hot technology and a developing trend, a cloud server works on a basic principle to improve efficiency of elastically expending IT basic platform while decrease cost by resource sharing. At present, establishment of a cloud server aims at providing services as required by users. The cloud server carries massive service systems and data, and different household appliances need to access the cloud server so as to provide relevant services to the users.

Therefore, it is necessary for the household appliance to access cloud servers in a convenient and effective way.

### SUMMARY

Embodiments of the present disclosure seek to solve at least one of the problems existing in the related art to at least some extent.

Accordingly, one embodiment of the present disclosure is to provide a cloud access method based on a wireless communication device. With this cloud access method, a household appliance can be connected to a corresponding cloud server, and the household appliance may access cloud servers, thereby improving an effect of cloud access based on the wireless communication device effectively.

Another embodiment of the present disclosure is to provide a cloud access system based on a wireless communication device.

Embodiments of the present disclosure provide a cloud access method based on a wireless communication device, including: receiving, by the wireless communication device, a first type message sent by a cloud server, and acquiring, by the wireless communication device, type information of the cloud server, and the wireless communication device is connected to cloud servers; calling, by the wireless communication device, a converting protocol according to the type information of the cloud server; and converting, by the wireless communication device, the first type message to a second type message according to the converting protocol, and sending by the wireless communication device the second type message to a corresponding household appliance.

With the cloud access method based on a wireless communication device according to embodiments of the present disclosure, the wireless communication device receives the first type message sent by the cloud server and acquires the type information of the cloud server, in which the wireless communication device is connected to cloud servers. The wireless communication device calls the converting protocol according to the type information of the cloud server. The wireless communication device converts the first type message to a second type message according to the converting protocol, and sends the second type message to a corresponding household appliance. Therefore, the household appliance can be connected to corresponding cloud server, and the household appliance accesses cloud servers, thereby improving an effect of cloud access based on the wireless communication device effectively.

Embodiments of the present disclosure provide a cloud access system based on a wireless communication device, including: the wireless communication device, the household appliance, and a cloud server communicating with the household appliance via the wireless communication device, in which the wireless communication device includes: a series data receiving and sending thread, configured to communicate with the household appliance; a network data receiving and sending thread, configured to communicate with the cloud server; a service logic thread, configured to exchange messages with the series data receiving and sending thread and the network data receiving and sending thread, and to control the messages received and sent by the series data receiving and sending thread and the network data receiving and sending thread; a main thread, configured to control the series data receiving and sending thread, the network data receiving and sending thread and the service logic thread; an application event recalling sub-device, via which the main thread controls the service logic thread; an application event message queue, configured to receive an event message and to provide the event message to the main thread to read, and the event message comprises an application event message and a WIFI recalling event message; an event distributing processing sub-device of a state machine, configured to distribute the event message to a corresponding state machine according to a mode attribute of the event message, and the mode attribute is one of AP-Mode, STA-Mode and System; to read the application event message and the WIFI recalling event message in the application event message queue; and to configure a state shifting mechanism of the wireless communication device; and the state machine, configured to control the wireless communication device to switch a state according to the event message and a state shifting mechanism.

With the cloud access system based on a wireless communication device according to embodiments of the present disclosure, the service logic thread exchanges messages with the series data receiving and sending thread and the network data receiving and sending thread so as to control the messages received and sent by the series data receiving and sending thread and the network data receiving and sending thread. The main thread controls the series data receiving and sending thread, the network data receiving and sending thread and the service logic thread, such that threads operates collaboratively, thereby improving effects of a thread scheduling in a cloud server accessing process effectively and allowing function expansion of a hardware system of the wireless communication device. By distributing the event message to a corresponding state machine according to a mode attribute of the event message, in which the mode attribute is one of AP-Mode, STA-Mode and System; and by controlling the wireless communication device to switch a state according to the event message and a state shifting mechanism of the corresponding state machine, three types of the state machines in the wireless communication device of the household appliance operate collaboratively, thereby improving an effect of state management of the wireless communication device effectively.

Embodiments of present disclosure will be given in part in the following descriptions, become apparent in part from the following descriptions, or be learned from the practice of the embodiments of the present disclosure.

### BRIEF DESCRIPTION OF THE DRAWINGS

Embodiments of the present disclosure will become apparent and more readily appreciated from the following descriptions made with reference to the drawings, in which:

FIG. 1 is a flow chart showing a cloud access method based on a wireless communication device according to an embodiment of the present disclosure;

FIG. 2 is a structure diagram showing hardware in a wireless communication device according to an embodiment of the present disclosure;

FIG. 3 is a flow chart showing message exchange in a wireless communication device according to an embodiment of the present disclosure;

FIG. 4 is a flow chart showing a cloud access method based on a wireless communication device according to another embodiment of the present disclosure;

FIG. 5 is a structure diagram showing hardware in a wireless communication device according to another embodiment of the present disclosure;

FIG. 6 is a flow chart showing a method for managing a state machine of a wireless communication device by a main thread according to another embodiment of the present disclosure;

FIG. 7 is a flow chart showing a method for managing a state machine of a wireless communication device by a main thread according to another embodiment of the present disclosure;

FIG. 8 is a schematic diagram showing state switch of a wireless communication device according to an embodiment of the present disclosure; and

FIG. 9 is a structure diagram of a cloud access system based on a wireless communication device according to another embodiment of the present disclosure.

### DETAILED DESCRIPTION

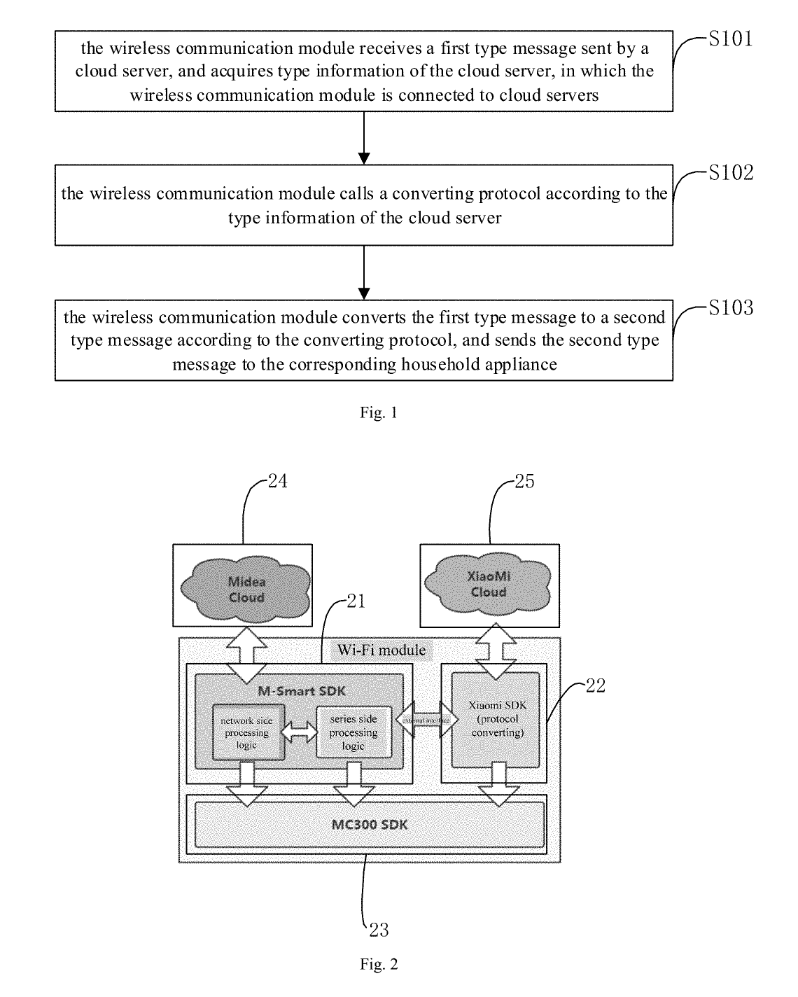

FIG. 1 is a flow chart showing a cloud access method based on a wireless communication device according to an embodiment of the present disclosure. The cloud access method includes the following.

At block S101, the wireless communication device receives a first type message sent by a cloud server, and acquires type information of the cloud server, in which the wireless communication device is connected to cloud servers.

In recent years, as a hot technology and a developing trend, a cloud server works on a basic principle which aims to improve efficiency of elastically expending IT basic platform while decrease cost by resource sharing. At present, establishment of the cloud server aims at providing services as required by users. The cloud server carries massive service systems and data, and different household appliances need to access the cloud server so as to provide relevant service to the users. Therefore, there are many demands and challenges of accessing the cloud server, and it is necessary for the household appliance to access cloud servers in a convenient and effective way.

In embodiments of the present disclosure, the wireless communication device is a WIFI communication device.

The WIFI communication device enabling Wi-Fi technology is applied to a household appliance.

The household appliance is, for example, an air conditioner, a refrigerator and a water heater and the like.

For example, an asymmetric digital subscriber line (ADSL for short) in a user's house, a broadband applied in a residential area and the like may be connected to the wireless communication device by a household Wi-Fi connection such that a mobile terminal may access the network.

Further, for example, in embodiments of the present disclosure, the household appliance may be connected to the corresponding cloud server via the wireless communication device, so as to realize resource sharing between the household appliance and the cloud server.

FIG. 2 is a structure diagram showing hardware in a wireless communication device according to an embodiment of the present disclosure. In FIG. 2, the MideaTM cloud and the Xiaomi cloud are taken as examples as the cloud servers.

In FIG. 2, an M-Smart software development kit (SDK) 21, a Xiaomi SDK 22, a manufacturer underlying SDK 23, the MideaTM cloud 24 and the Xiaomi cloud 25 are shown. The M-Smart SDK 21 is configured to realize processing logic of a service logic thread based on an M-smart system, the Xiaomi SDK 22 is configured to realize a protocol in a protocol converting file xm_profile.c of the Xiaomi cloud 25, the manufacturer underlying SDK 23 is configured to realize underlying hardware logic of the wireless communication device, the MideaTM cloud 24 and the Xiaomi cloud 25 are configured to provide cloud service resources.

The cloud server provides a computing service which is simple, effective, safe, reliable and of a flexible processing capacity. The cloud server is configured to provide integrated services to various internet users. The cloud server may be the MideaTM cloud, the Jingdong cloud, the Ali cloud or the Xiaomi cloud.

The cloud server has functions such as smart cloud access, smart cloud storage and smart information push. After the user connects the household appliance with the corresponding cloud server via the wireless communication device, the cloud service may push the resources to the household appliance, and the user may control the household appliance via a household appliance application in a mobile terminal.

For example, a MideaTM microwave oven has a newly-developed using function namely a cooking recipes resource, the manufacturer of the microwave oven stores the cooking recipes resource in a smart cloud storage of the MideaTM cloud, and the MideaTM cloud may push the cooking recipes resource to the MideaTM microwave oven after the user connects the MideaTM microwave oven with the MideaTM cloud via the wireless communication device, such that the user may control the MideaTM microwave oven via an application of the MideaTM microwave oven in a mobile terminal to perform the newly-developed cooking recipes resource.

A message is a unit of data exchanged and transmitted in a network, i.e., a data block sent by a site at once. The message includes complete data information to be sent, of which the lengths are different and the lengths are unlimited and changeable. The data may be packaged constantly as a group, a package and a frame to transmit.

In embodiments of the present disclosure, type information of the cloud server may be, for example, a cloud ID; and different cloud IDs identify different cloud servers. The cloud ID may be set in a message head of the first type message, such as in a reserved field in the message head or in other fields, which is not limited herein.

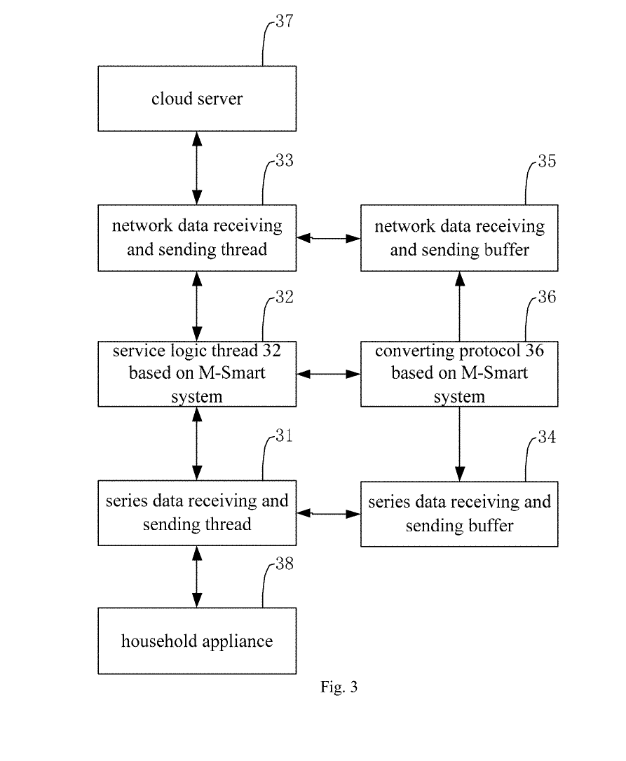

In an embodiment, as shown in FIG. 3, a flow chart showing message exchange in a wireless communication device according to an embodiment of the present disclosure. The wireless communication device includes a series data receiving and sending thread 31, a service logic thread 32 based on the M-Smart system, a network data receiving and sending thread 33, a series data receiving and sending buffer 34, a network data receiving and sending buffer 35, a converting protocol 36 based on M-Smart system, a cloud server 37 and a household appliance 38.

In an embodiment, acquiring type information of the cloud server further includes the following. The wireless communication device acquires connection information for a socket connected to the cloud server. The wireless communication device determines the type information according to the connection information for the socket.

For example, a process of exchanging messages which are sent is described as follows. After the network data receiving and sending thread in the wireless communication device acquires the first type message sent by the cloud server to the household appliance, the network data receiving and sending thread creates a network receiving and sending data package message queue, and adds the first type message to the network receiving and sending data package message queue. The service logic thread based on the M-Smart system in the wireless communication device acquires the first type message from a network data receiving and sending buffer corresponding to the network receiving and sending data package message queue via a functional interface of a protocol converting file in the cloud server SDK, and acquires a cloud ID in the message head of the first type message.

At block S102, the wireless communication device calls a converting protocol according to the type information of the cloud server.

A converting protocol corresponding to the type information of the cloud server may be, for example, a protocol in a protocol converting file ali_profile.c of the Ali cloud ali_sdk.c, a protocol in a protocol converting file jd_profile.c of the Jingdong cloud jd_sdk.c, a protocol in a protocol converting file xm_profile.c of the Xiaomi cloud xm_sdk.c, and a protocol in a protocol converting file md_profile.c of the MideaTM cloud md_sdk.c.

At block S103, the wireless communication device converts the first type message to a second type message according to the converting protocol, and sends the second type message to the corresponding household appliance.

For example, the wireless communication device converts the first type message according to the cloud ID in the message head of the first type message and the corresponding converting protocol so as to acquire the second type message, stores the second type message in a series data receiving and sending buffer allocated by a cloud access system, and triggers an application event recalling sub-device to control the service logic thread based on the M-Smart system to send the second type message to the household appliance via the series data receiving and sending thread.

In an embodiment, the cloud access method based on the wireless communication device includes the following. The wireless communication device receives the second type message sent by the household appliance, acquires a target address corresponding to the second type message, and determines the type information of the cloud server according to the target address. The wireless communication device calls the converting protocol according to the type information of the cloud server. The wireless communication device converts the second type message to the first type message according to the converting protocol, and sends the first type message to the cloud server.

In this embodiment, the wireless communication device receives the first type message sent by the cloud server and acquires the type information of the cloud server, in which the wireless communication device is connected to cloud servers. The wireless communication device calls the converting protocol according to the type information of the cloud server. The wireless communication device converts the first type message to a second type message according to the converting protocol, and sends the second type message to a corresponding household appliance. Therefore, the household appliance is connected to the corresponding cloud servers, such that the household appliance accesses cloud server, thereby improving an effect of cloud access based on the wireless communication device effectively.

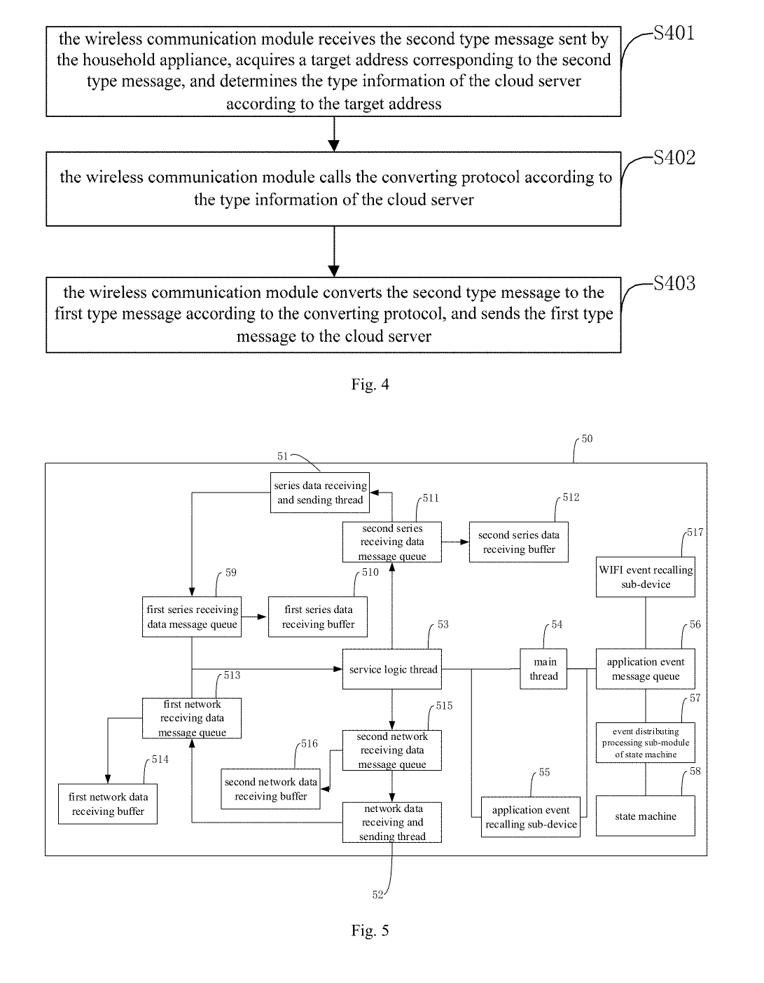

FIG. 4 is a flow chart showing a cloud access method based on a wireless communication device according to another embodiment of the present disclosure. The cloud access method based on the wireless communication device may include the following.

At block S401, the wireless communication device receives the second type message sent by the household appliance, acquires a target address corresponding to the second type message, and determines the type information of the cloud server according to the target address.

In embodiments of the present disclosure, the target address corresponding to the second type message identifies the cloud server, and the target address may be set in a message head of the second type message, such as in a reserved field in the message head or in other fields, which is not limited in the embodiments of the present disclosure.

In an embodiment, as shown in FIG. 3, a process of exchanging messages which are sent is described as follows. After the series data receiving and sending thread in the wireless communication device receives the second type message sent by the household appliance, the series data receiving and sending thread creates a series receiving and sending data package message queue, and adds the second type message to the series receiving and sending data package message queue. The service logic thread based on the M-Smart system in the wireless communication device acquires the second type message from a series data receiving and sending buffer corresponding to the series receiving and sending data package message queue via a functional interface of a protocol converting file in the cloud server SDK, and determines the type information of the corresponding cloud server according to the target address in the message head of the second type message.

At block S402, the wireless communication device calls the converting protocol according to the type information of the cloud server.

A converting protocol corresponding to the type information of the cloud server may be, for example, a protocol in a protocol converting file ali_profile.c of the Ali cloud ali_sdk.c, a protocol in a protocol converting file jd_profile.c of the Jingdong cloud jd_sdk.c, a protocol in a protocol converting file xm_profile.c of the Xiaomi cloud xm_sdk.c, and a protocol in a protocol converting file md_profile.c of the MideaTM cloud md_sdk.c.

At block S403, the wireless communication device converts the second type message to the first type message according to the converting protocol, and sends the first type message to the cloud server.

For example, the wireless communication device converts the second type message according to the corresponding converting protocol so as to acquire the first type message, stores the first type message in a network data receiving and sending buffer allocated by a cloud access system, and triggers an application event recalling sub-device to control the service logic thread based on the M-Smart system report the first type message to the cloud server via the network data receiving and sending thread.

In this embodiment, the wireless communication device receives the second type message sent by the household appliance and the target address corresponding to the second type message; and determines the type information of the cloud server according to the target address. The wireless communication device converts the second type message to the first type message according to the converting protocol corresponding to the type information of the cloud server, and sends the first type message to the corresponding cloud server. Therefore, the household appliance reports the message to the corresponding cloud server, such that the household appliance access cloud servers, thereby improving an effect of cloud access based on the wireless communication device effectively.

FIG. 5 is a structure diagram showing hardware in a wireless communication device 50 according to another embodiment of the present disclosure. The wireless communication device 50 includes: a series data receiving and sending thread 51, configured to communicate with the household appliance; a network data receiving and sending thread 52, configured to communicate with the cloud server; a service logic thread 53, configured to exchange messages with the series data receiving and sending thread 51 and the network data receiving and sending thread 52, and to control the messages received and sent by the series data receiving and sending thread 51 and the network data receiving and sending thread 52; a main thread 54, configured to control the series data receiving and sending thread 51, the network data receiving and sending thread 52 and the service logic thread 53; an application event recalling sub-device 55, via which the main thread 54 controls the service logic thread 53; an application event message queue 56, configured to receive an event message and to provide the event message to the main thread 54 to read, in which the event message includes an application event message and a WIFI recalling event message; an event distributing processing sub-device 57 of a state machine 58, configured to distribute the event message to the state machine 58 according to a mode attribute of the event message, in which the mode attribute is one of AP-Mode, STA-Mode and System; to read the application event message and the WIFI recalling event message in the application event message queue 56; and to configure a state shifting mechanism of the wireless communication device 50; and the state machine 58, configured to control the wireless communication device 50 to switch a state according to the event message and a state shifting mechanism.

In an embodiment of the present disclosure, the wireless communication device 50 includes a series data receiving and sending thread 51, configured to communicate with the household appliance.

The wording “series” means “serial interface”, which is an expanding interface in a series communication manner. The series communication manner means that each bit of data in a message is transmitted in a bit order.

A thread is the minimum unit of a program execution flow. A standard thread is consist of a thread ID, a current pointer command (PC), a register set and a stack. The thread is used for a file management or a communication control in a server.

For example, when the wireless communication device 50 receives the message sent by the household appliance, the message is processed in a series communication manner, and the processed message is reported to the cloud server.

In an embodiment of the present disclosure, the wireless communication device 50 also includes a network data receiving and sending thread 52, configured to communicate with the cloud server.

For example, when the wireless communication device 50 receives the message sent by the cloud server via the network data receiving and sending thread 52, the message is processed, and the processed message is sent to the household appliance.

In an embodiment of the present disclosure, the wireless communication device 50 also includes a service logic thread 53, configured to exchange messages with the series data receiving and sending thread 51 and the network data receiving and sending thread 52, and to control the messages received and sent by the series data receiving and sending thread 51 and the network data receiving and sending thread 52.

The service logic thread 53 in embodiments of the present disclosure is a service logic thread 53 based on an M-Smart system. The M-Smart system is open to provide specific services, and the M-Smart system is open to provide an interchange form for internet cooperators using a third party cloud, the MideaTM built-in cloud or no cloud.

In an embodiment, the service logic thread 53 exchanges messages with the series data receiving and sending thread 51 and the network data receiving and sending thread 52 via an M-Smart protocol.

In an embodiment, the service logic thread 53 acquires the first type message sent by the cloud server to the household appliance via the network data receiving and sending thread 52, acquires type information of the cloud server, converts the first type message to a second type message according to the type information and sends the second type message to the household appliance via a series data receiving thread.

A message is a unit of data exchanged and transmitted in a network, i.e., a data block sent by a site at once. The message includes complete data information to be sent, of which the lengths are different and the lengths are unlimited and changeable. The data may be packaged constantly as a group, a package and a frame to transmit.

In embodiments of the present disclosure, type information of the cloud server may be, for example, a cloud ID; and different cloud IDs identify different cloud servers. The cloud ID may be set in a message head of the first type message, such as in a reserved field in the message head or in other fields, which is not limited in the embodiments of the present disclosure.

In an embodiment, acquiring type information of the cloud server further includes the following. The wireless communication device 50 acquires connection information for a socket connected to the cloud server. The wireless communication device 50 determines the type information according to the connection information for the socket.

For example, a process of exchanging messages which are sent is described as follows. After the network data receiving and sending thread 52 in the wireless communication device 50 requires the first type message sent by the cloud server to the household appliance, the network data receiving and sending thread 52 creates a network receiving and sending data package message queue, and adds the first type message to the network receiving and sending data package message queue. The service logic thread 53 based on the M-Smart system in the wireless communication device 50 acquires the first type message from a network data receiving and sending buffer corresponding to the network receiving and sending data package message queue via a functional interface of a protocol converting file in the cloud server SDK, acquires a cloud ID in the message head of the first type message, converts the first type message according to the protocol so as to acquire the second type message, stores the second type message in a series data receiving and sending buffer allocated by a cloud access system, and triggers the application event recalling sub-device 55 to control the service logic thread 53 based on the M-Smart system to send the second type message to the household appliance via the series data receiving and sending thread 51. A protocol converting file in the cloud server SDK may be, for example, a protocol converting file ali_profile.c of the Ali cloud ali_sdk.c, a protocol converting file jd_profile.c of the Jingdong cloud jd_sdk.c, a protocol converting file xm_profile.c of the Xiaomi cloud xm_sdk.c, and a protocol converting file md_profile.c of the MideaTM cloud md_sdk.c.

In an embodiment, the wireless communication device 50 receives the second type message sent by the household appliance; acquires a target address corresponding to the second type message; and determines the type information of the cloud server according to the target address. The wireless communication device 50 calls the converting protocol according to the type information of the cloud server. The wireless communication device 50 converts the second type message to the first type message according to the converting protocol, and sends the first type message to the corresponding cloud server.

In embodiments of the present disclosure, the target address corresponding to the second type message identifies the cloud server. The target address may be set in a message head of the second type message, such as in a reserved field in the message head or in other fields, which is not limited in the embodiments of the present disclosure.

In an embodiment, a process of exchanging messages which are reported may be described as follows. After the series data receiving and sending thread 51 in the wireless communication device 50 receives the second type message sent by the household appliance, the series data receiving and sending thread 51 creates a series receiving and sending data package message queue, and adds the second type message to the series receiving and sending data package message queue. The service logic thread 53 based on the M-Smart system in the wireless communication device 50 acquires the second type message from a series data receiving and sending buffer corresponding to the series receiving and sending data package message queue via a functional interface of a protocol converting file in the cloud server SDK, converts the second type message according to the type information of the cloud server corresponding to the target address in the message head of the second type message so as to acquire the first type message, stores the first type message in a network data receiving and sending buffer allocated by a cloud access system, and triggers an application event recalling sub-device 55 to control the service logic thread 53 based on the M-Smart system to report the first type message to the cloud server via the network data receiving and sending thread 52.

In an embodiment of the present disclosure, the wireless communication device 50 also includes a main thread 54 configured to control the series data receiving and sending thread 51, the network data receiving and sending thread 52 and the service logic thread 53.

In an embodiment of the present disclosure, the wireless communication device 50 also includes an application event recalling sub-device 55, via which the main thread 54 controls the service logic thread 53.

In an embodiment of the present disclosure, the wireless communication device 50 also includes an application event message queue 56, configured to receive an application event message generated by the service logic thread 53 and to provide the event message to the main thread 54 to read.

For example, when the cloud server sends messages, or when the household appliance reports messages, the service logic thread 53 generates a corresponding application event message, adds the application event message in the application event message queue 56 such that the main thread 54 read the application event message, and triggers the application event recalling sub-device 55 to control the service logic thread 53 based on the M-Smart system to report the first type message to the cloud server via the network data receiving and sending thread 52, or, triggers the application event recalling sub-device 55 to control the service logic thread 53 based on the M-Smart system to send the second type message to the household appliance via the series data receiving and sending thread 51.

In an embodiment of the present disclosure, the wireless communication device 50 also includes an event distributing processing sub-device 57 of a state machine 58. The event distributing processing sub-device 57 of a state machine 58 is configured to distribute the event message to the state machine 58 according to a mode attribute of the event message, in which the mode attribute is one of AP-Mode, STA-Mode and System; to read the application event message and the WIFI recalling event message in the application event message queue 56; and to configure a state shifting mechanism of the wireless communication device 50.

In an embodiment of the present disclosure, the wireless communication device 50 also includes the state machine 58, configured to control the wireless communication device 50 to switch a state according to the event message and a state shifting mechanism.

In an embodiment, the main thread 54 is configured to manage the state machine 58 in the wireless communication device 50.

The main thread 54 manages the state machine 58 in the wireless communication device 50, which includes the following. The wireless communication device 50 receives an event message. The wireless communication device 50 distributes the event message to a corresponding state machine 58 according to a mode attribute of the event message, in which the mode attribute is one of AP-Mode, STA-Mode and System. The wireless communication device 50 controls the wireless communication device 50 to switch a state according to the event message and a state shifting mechanism of the corresponding state machine 58.

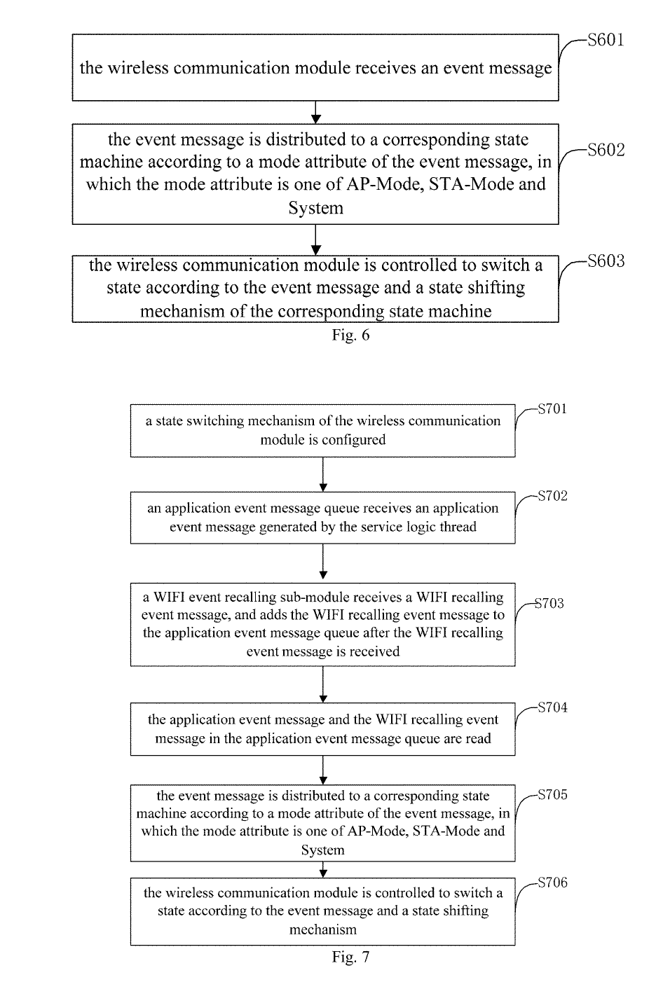

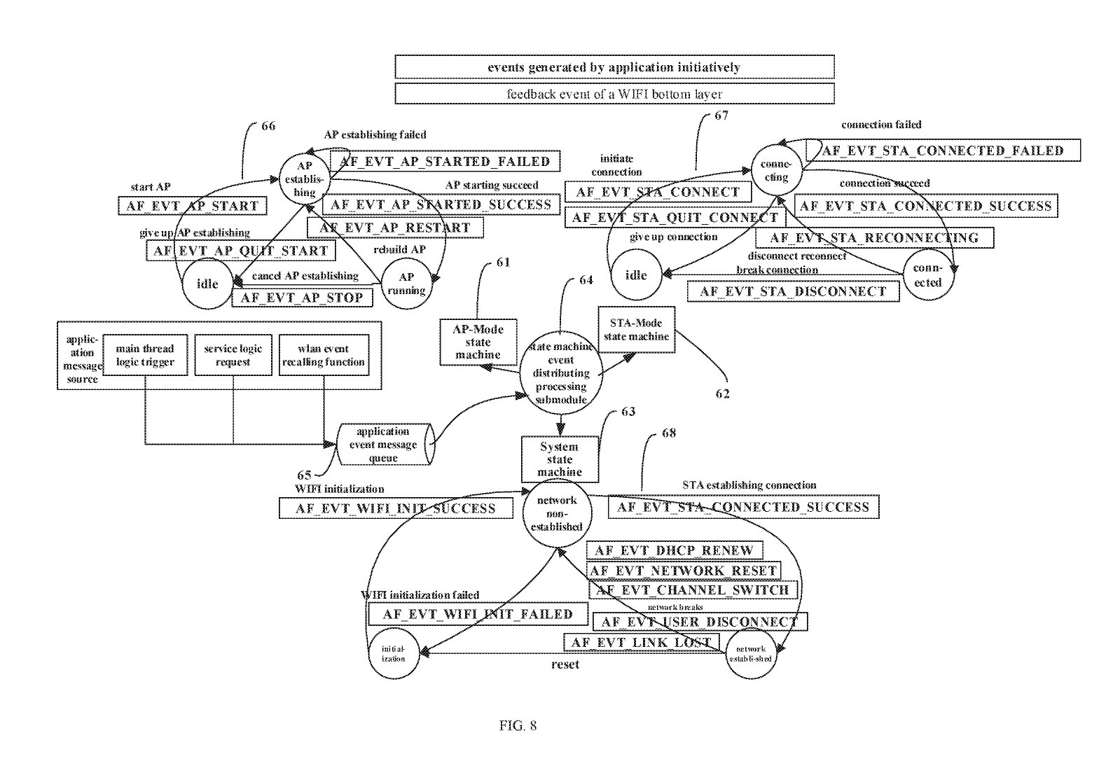

In an embodiment, examples of a process of managing by the main thread 54 the state machine 58 in the wireless communication device 50 are illustrated in FIG. 6 and FIG. 7.

In an embodiment, the wireless communication device 50 also includes a first series receiving data message queue 59, configured to receive a message sent by the series data receiving and sending thread 51, and to provide the message sent by the series data receiving and sending thread 51 to the service logic thread 53 to read; a first series data receiving buffer 510, configured to receive and buffer data sent by the series data receiving and sending thread 51, and to provide the data sent by the series data receiving and sending thread 51 to the service logic thread 53 to read; a second series receiving data message queue 511, configured to receive a message sent by the service logic thread 53, and to provide the message sent by the service logic thread 53 to the series data receiving and sending thread 51 to read; and a second series data receiving buffer 512, configured to receive and buffer data sent by the service logic thread 53, and to provide the data sent by the service logic thread 53 to the series data receiving and sending thread 51 to read.

In an embodiment, a process of reporting messages by the household appliance may be described as follows. After the series data receiving and sending thread 51 in the wireless communication device 50 receives the second type message sent by the household appliance, the series data receiving and sending thread 51 creates a first series receiving data message queue 59, and adds the second type message to the first series receiving data message queue 59. The service logic thread 53 based on the M-Smart system in the wireless communication device 50 acquires the second type message from the first series data receiving buffer 510 corresponding to the first series receiving data message queue 59 via a functional interface of a protocol converting file in the cloud server SDK, and converts the second type message according to the type information of the cloud server corresponding to the target address in the message head of the second type message so as to acquire the first type message.

Further, in a process of sending messages by the cloud server, the service logic thread 53 based on the M-Smart system in the wireless communication device 50 requires the first type message from a network data receiving and sending buffer corresponding to a network receiving and sending data package message queue via a functional interface of a protocol converting file in the cloud server SDK, converts the first type message according to the cloud ID in the message head of the first type message so as to acquire the second type message, stores the second type message in the second series data receiving buffer 512 corresponding to the second series receiving data message queue 511, and triggers the application event recalling sub-device 55 to control the service logic thread 53 based on the M-Smart system to send the second type message to the household appliance via the series data receiving and sending thread 51.

In an embodiment, after the data of the first series data receiving buffer 510 and the second series data receiving buffer 512 are read, the data are deleted from the first series data receiving buffer 510 and the second series data receiving buffer 512.

In an embodiment of the present disclosure, the wireless communication device 50 also includes: a first network receiving data message queue 513, configured to receive messages sent by the network data receiving and sending thread 52, and to provide the messages sent by the network data receiving and sending thread 52 to the service logic thread 53 to read; a first network data receiving buffer 514, configured to receive and buffer data sent by the network data receiving and sending thread 52, and to provide the data sent by the network data receiving and sending thread 52 to the service logic thread 53 to read; a second network receiving data message queue 515, configured to receive messages sent by the service logic thread 53, and to provide the messages sent by the service logic thread 53 to the network data receiving and sending thread 52 to read; and a second network data receiving buffer 516, configured to receive and buffer data sent by the service logic thread 53, and to provide the data sent by the service logic thread 53 to the network data receiving and sending thread 52 to read.

In an embodiment, in a process of reporting messages by the household appliance, the service logic thread 53 stores the first type message in the second network data receiving buffer 516 allocated by the cloud access system via the second network receiving data message queue 515, and triggers an application event recalling sub-device 55 to control the service logic thread 53 based on the M-Smart system to report the first type message to the cloud server via the network data receiving and sending thread 52.

Further, in a process of sending messages by the cloud server, after the first network receiving data message queue 513 in the wireless communication device 50 receives the first type message sent by the cloud server to the household appliance via the network data receiving and sending buffer 52, the network data receiving and sending buffer 52 creates the first network data receiving buffer 514, adds the first type message to the first network data receiving buffer 514 and provides the data to the service logic thread 53 to read, such that the service logic thread 53 based on the M-Smart system sends the second type message to the household appliance via the series data receiving and sending thread 51.

In an embodiment, after the data of the first network data receiving buffer 514 and the second network data receiving buffer 516 are read, the data are deleted from the first network data receiving buffer 514 and the second network data receiving buffer 516.

In an embodiment of the present disclosure, the wireless communication device 50 also includes: a WIFI event recalling sub-device 517, configured to receive a WIFI recalling event, and to add the WIFI recalling event to the application event message queue 56 after the WIFI recalling event is received.

The WIFI recalling event is generated by an application program. In one embodiment, the application program may be the application program in the wireless communication device 50.

For example, after the WIFI recalling event is received by the WIFI event recalling sub-device 517, the WIFI recalling event may be added to the application event message queue 56 and provided to the main thread 54 to read.

In this embodiment, the service logic thread exchanges messages with the series data receiving and sending thread and the network data receiving and sending thread so as to control the messages received and sent by the series data receiving and sending thread and the network data receiving and sending thread. The main thread controls the series data receiving and sending thread, the network data receiving and sending thread and the service logic thread, such that threads operates collaboratively, thereby improving an effect of a thread scheduling in a cloud server accessing process effectively and allowing function expansion of a hardware system of the wireless communication device. By distributing the event message to a corresponding state machine according to a mode attribute of the event message, in which the mode attribute is one of AP-Mode, STA-Mode and System; and by controlling the wireless communication device to switch a state according to the event message and a state shifting mechanism of the corresponding state machine, three types of the state machines in the wireless communication device of the household appliance operates collaboratively, thereby improving an effect of state management of the wireless communication device effectively.

FIG. 6 is a flow chart showing a method for managing a state machine of a wireless communication device by a main thread according to another embodiment of the present disclosure. The method for managing the state machine of the wireless communication device by the main thread may include the following.

At block S601, the wireless communication device receives an event message.

In embodiments of the present disclosure, the wireless communication device is a WIFI communication device.

The WIFI communication device enabling Wi-Fi technology is applied to a household appliance.

The household appliance is, for example, an air conditioner, a refrigerator and a water heater and the like.

For example, an asymmetric digital subscriber line (ADSL for short) in a user's house, a broadband applied in a residential area and the like may be connected to the wireless communication device by a household Wi-Fi connection such that a mobile terminal may access the network. Further, the household appliance may be connected to the corresponding cloud server via the wireless communication device, so as to realize resource sharing between the household appliance and the cloud server.

At present, the wireless communication device in the household appliance is usually considered as a receiving terminal to use, which means that a network providing device (such as a wired network) is needed to provide network to the household appliance. However, the user may want to use the wireless communication device to broaden a range covered by the network signal, or may want to transform a wired network to a wireless network with the wireless communication device, or may want to allow the wireless communication to serve as a wireless access point (AP) to connect electronic devices. In the related arts, the wireless communication device in the household appliance may generally provide only one network configuration or function.

In an embodiment, the event message includes an application event message and a WIFI recalling event message. The wireless communication device receives the event message, which includes the following. An application event message queue receives the application event message generated by a service logic thread. A WIFI event recalling sub-device receives a WIFI recalling event message, and adds the WIFI recalling event message to the application event message queue after the WIFI recalling event message is received.

The application event message is generated by the main thread in the wireless communication device by the application recalling sub-device controlling the service logic thread.

The WIFI recalling event message is generated by an application program.

In an embodiment, the application event message may be an event generated by an upper layer application of the wireless communication device initiatively. For example, the application event message AF_EVT_AP_STOP is generated when the wireless communication device cancels AP mode.

The WIFI recalling event message may be a feedback event of a WIFI bottom layer of the wireless communication device. For example, the WIFI recalling event message AF_EVT_AP_STOP_STARTED_SUCCESS is generated when the wireless communication device starts the AP mode successfully.

In an embodiment, before the wireless communication device receives the event message, the method further includes the following. A state shifting mechanism of the wireless communication device is configured.

At block S602, the event message is distributed to a corresponding state machine according to a mode attribute of the event message, in which the mode attribute is one of AP-Mode, STA-Mode and System.

In an embodiment, a state machine event distributing processing sub-device may distributes the event message to the corresponding state machine according to the mode attribute of the event message, in which the mode attribute is one of AP-Mode, STA-Mode and System.

The wireless communication device supports an access point (AP for short) working mode AP-Mode, in which the AP-Mode is applied to the access of a wireless local area network member device (i.e., a client side), i.e., a network downward, to provide a wireless local area network (WLAN) built in a wireless manner, such that the device may be considered as a central device of WLAN. The wireless communication device may also support a working station mode STA-Mode, which may be understood as a working station in a certain network grid, i.e., the client side. When a WIFI chip in the wireless communication device provides an STA-Mode function, the wireless communication device may be connected to another network grid. The AP-Mode is provided to connection of a mobile terminal and the like, and the STA-Mode is configured to provide a data uplink service of the network. In addition, a system network state of a system including the wireless communication device (i.e., a network connecting state between the system including the wireless communication device and the user) may be described by a system state attribute, and a system state machine may perform a switching management between the system states.

The state machine includes an AP-Mode state machine, a STA-Mode state machine and a System state machine, and the mode attribute AP-Mode corresponds to the AP-Mode state machine, the mode attribute STA-Mode corresponds to the STA-Mode state machine, and the mode attribute System corresponds to the System state machine.

At block S603, the wireless communication device is controlled to switch a state according to the event message and a state shifting mechanism of the corresponding state machine.

The state of the wireless communication device includes an AP establishing state, an AP running state and an idle state in the AP-Mode state machine, a connecting state, a connected state and an idle state in the STA-Mode state machine and a network non-established state, a network established state and an initialization state in the System state machine.

In an embodiment, controlling the wireless communication device to switch a state according to the event message and a state shifting mechanism of the corresponding state machine includes the following. The AP-Mode state machine controls the wireless communication device to switch the state among the AP establishing state, the AP running state and the idle state according to the event message and a state shifting mechanism of the AP-Mode state machine when the mode attribute of the event message is AP-Mode. The STA-Mode state machine controls the wireless communication device to switch the state among the connecting state, the connected state and the idle state according to the event message and a state shifting mechanism of the STA-Mode state machine when the mode attribute of the event message is STA-Mode. The System state machine controls the wireless communication device to switch the state among the network non-established state, the network established state and the initialization state according to the event message and a state shifting mechanism of the System state machine when the mode attribute of the event message is System.

In this embodiment, by distributing the event message to a corresponding state machine according to a mode attribute of the event message, in which the mode attribute is one of AP-Mode, STA-Mode and System, and by controlling the wireless communication device to switch a state according to the event message and a state shifting mechanism of the corresponding state machine, three types of the state machines in the wireless communication device of the household appliance operates collaboratively, thereby improving an effect of state management of the wireless communication device effectively.

FIG. 7 is a flow chart showing a method for managing a state machine of a wireless communication device by a main thread according to another embodiment of the present disclosure. The method for managing the state machine of the wireless communication device by the main thread may include the following.

At block S701, a state shifting mechanism of the wireless communication device is configured.

The wireless communication device is a WIFI communication device.

The WIFI communication device enabling Wi-Fi technology is applied to a household appliance.

In an embodiment, state attributes of the AP-Mode state machine, the STA-Mode state machine and the System state machine are integrated to configure the state shifting mechanism of the wireless communication device.

The state attributes are configured to identify states of the wireless communication device.

With this block, a built-in program in the wireless communication device may call a configured state attribute, such that the state of the wireless communication device may be switched among different states, and three types of the state machines in the wireless communication device of the household appliance may operate collaboratively.

At block S702, an application event message queue receives an application event message generated by the service logic thread.

The application event message is generated by the main thread in the wireless communication device by the application event recalling sub-device controlling the service logic thread.

In an embodiment, the application event message may be an event generated by an upper layer application of the wireless communication device initiatively. For example, the application event message AF_EVT_AP_STOP is generated when the wireless communication device cancels AP mode.

At block S703, a WIFI event recalling sub-device receives a WIFI recalling event message, and adds the WIFI recalling event message to the application event message queue after the WIFI recalling event message is received.

The WIFI recalling event message may be a feedback event of a WIFI bottom layer of the wireless communication device. For example, the WIFI recalling event message AF_EVT_AP_STOP_STARTED_SUCCESS is generated when the wireless communication device starts the AP mode successfully.

At block S704, the application event message and the WIFI recalling event message in the application event message queue are read.

In an embodiment, the main thread in the wireless communication device reads the application event message and the WIFI recalling event message in the application event message queue via a state machine event distributing processing sub-device.

At block S705, the event message is distributed to a corresponding state machine according to a mode attribute of the event message, in which the mode attribute is one of AP-Mode, STA-Mode and System.

In an embodiment, the event message is distributed to a corresponding state machine by the state machine event distributing processing sub-device according to a mode attribute of the event message, in which the mode attribute is one of AP-Mode, STA-Mode and System.

The wireless communication device supports an access point (AP for short) working mode AP-Mode, in which the AP-Mode is applied to access of a wireless local area network member device (i.e., a client side), i.e., a network downward, to provide a wireless local area network (WLAN) built in a wireless manner, such that the device may be considered as a central device of WLAN. The wireless communication device may also support a working station mode STA-Mode, which may be understood as a working station in a certain network grid, i.e., the client side. When a WIFI chip in the wireless communication device provides an STA-Mode function, the wireless communication device may be connected to another network grid. The AP-Mode is provided to connection of a mobile terminal and the like, and the STA-Mode is configured to provide a data uplink service of the network. In addition, a system network state of a system including the wireless communication device (i.e., a network connecting state between the system including the wireless communication device and the user) may be described by a system state attribute, and a system state machine may perform a switching management between the system states.

The state machine includes an AP-Mode state machine, a STA-Mode state machine and a System state machine, and the mode attribute AP-Mode corresponds to the AP-Mode state machine, the mode attribute STA-Mode corresponds to the STA-Mode state machine, and the mode attribute System corresponds to the System state machine.

By distributing the event message to the corresponding state machine so as to perform state management respectively, the logicality of a code structure can be enhanced in terms of realizing an underlying hardware of the wireless communication device, thereby reducing complexity of code development and allowing function expansion of the wireless communication device hardware system.

At block S706, the wireless communication device is controlled to switch a state according to the event message and a state shifting mechanism.

In an embodiment, as shown in FIG. 8, a schematic diagram showing state switching of a wireless communication device according to an embodiment of the present disclosure, an AP-Mode state machine 81, a STA-Mode state machine 82, a System state machine 83, a state machine event distributing processing sub-device 84, an application event message queue 85, an AP-Mode state machine state switching process 86, a STA-Mode state machine state switching process 87 and a System state machine state switching process 88 are illustrated.

The wireless communication device may be controlled to switch the state according to a content of the event message and the state shifting mechanism of the corresponding state machine.

For example, as shown in FIG. 8, when the wireless communication device cancels the AP mode, the application event message AF_EVT_AP_STOP is generated, and the content of the application event message AF_EVT_AP_STOP is cancelling AP mode. When the wireless communication device is in an AP running state, and the main thread of the wireless communication device reads the application event message AF_EVT_AP_STOP, the AP-Mode state machine controls the wireless communication device to switch the AP running state to an idle state.

In this embodiment, by configuring the state shifting mechanism of the wireless communication device, a built-in program in the wireless communication device may call a configured state attribute, such that the state of the wireless communication device may be switched among different states. By distributing the event message to the corresponding state machine according to the mode attribute of the event message, in which the mode attribute is one of AP-Mode, STA-Mode and System, and by controlling the wireless communication device to switch a state according to the event message and a state shifting mechanism of the corresponding state machine, three types of the state machines in the wireless communication device of the household appliance operates collaboratively, thereby improving an effect of state management of the wireless communication device effectively. By distributing the event message to the corresponding state machine so as to perform state management respectively, the logicality of a code structure can be enhanced in terms of realizing a bottom layer hardware of the wireless communication device, thereby reducing complexity of code development and allowing function expansion of the wireless communication device hardware system.

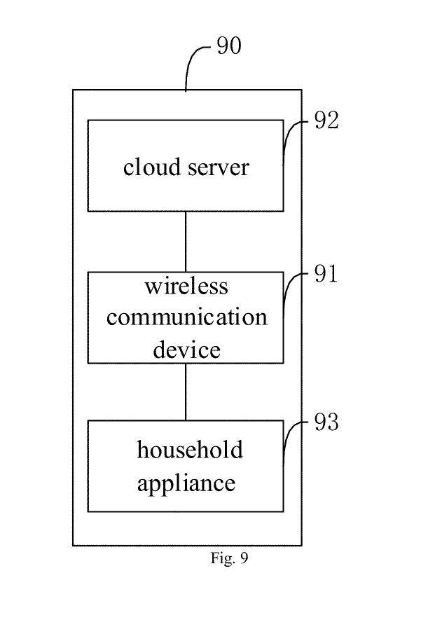

FIG. 9 is a structure diagram showing a cloud access system based on a wireless communication device 91 according to another embodiment of the present disclosure. The cloud access system based on the wireless communication device 91 includes the wireless communication device 91, a cloud server 92 and a household appliance 93 communicating with each other via the wireless communication device 91, in which the wireless communication device 91 also includes a series data receiving and sending thread, configured to communicate with the household appliance 93; a network data receiving and sending thread, configured to communicate with the cloud server 92; a service logic thread, configured to exchange messages with the series data receiving and sending thread and the network data receiving and sending thread, and to control the messages received and sent by the series data receiving and sending thread and the network data receiving and sending thread; a main thread, configured to control the series data receiving and sending thread, the network data receiving and sending thread and the service logic thread; an application event recalling sub-device, via which the main thread controls the service logic thread; an application event message queue, configured to receive an event message and to provide the event message to the main thread to read, in which the event message includes an application event message and a WIFI recalling event message; an event distributing processing sub-device of a state machine, configured to distribute the event message to a corresponding state machine according to a mode attribute of the event message, in which the mode attribute is one of AP-Mode, STA-Mode and System; to read the application event message and the WIFI recalling event message in the application event message queue; and to configure a state shifting mechanism of the wireless communication device 91; and the state machine, configured to control the wireless communication device 91 to switch a state according to the event message and a state shifting mechanism.

In recent years, as a hot technology and a developing trend, the cloud server 92 works on a basic principle to improve efficiency of elastically expending IT basic platform while decrease cost by resource sharing. At present, establishments of the cloud server 92 aims at providing services as required by users. The cloud server 92 carries massive service systems and data, and different household appliances 93 need to access the cloud servers 92 so as to provide relevant services to the users. Therefore, there are many demands and challenges of accessing the cloud server 92.

In embodiments of the present disclosure, the cloud access system based on the wireless communication device 91 includes the wireless communication device 91.

Embodiments of the wireless communication device 91 are described in the example of FIG. 5, which is not described herein.

In embodiments of the present disclosure, the cloud access system based on the wireless communication device 91 also includes the cloud server 92 and the household appliance 93 communicating with each other via the wireless communication device 91.

The cloud server 92 provides a computing service which is simple, effective, safe, reliable and of a flexible processing capacity. The cloud server 92 is configured to provide integrated services to various internet users. The cloud server 92 may be the MideaTM™ cloud, the Jingdong™ cloud, the Ali™ cloud or the Xiaomi™ cloud.

The cloud server 92 has functions such as smart cloud access, smart cloud storage and smart information push. After the user connects the household appliance 93 with the corresponding cloud server 92 via the wireless communication device 91, the cloud service 92 may push the resources to the household appliance 93, and the user may control the household appliance 93 via an application of the household appliance 93 in a mobile terminal.

For example, a Midea™ microwave oven has a newly-developed using function namely a cooking recipes resource, the manufacturer of the microwave oven stores the cooking recipes resource in a smart cloud storage of the Midea™ cloud, and the Midea™ cloud may push the cooking recipes resource to the Midea™ microwave oven after the user connects the Midea™ microwave oven with the Midea™ cloud via the wireless communication device 91, such that the user may control the Midea™ microwave oven via an application of the Midea™ microwave oven in a mobile terminal to perform the newly-developed cooking recipes resource.

The household appliance 93 refers to electric and electronic devices used in a house and the like. The household appliance 93 may be a television, a refrigerator or an air conditioner and the like.

With the development of smart home technology and the improvement of user's living level, more and more household appliances 93 may realize a smart operating. The user may install an application of the household appliance 93 in a mobile terminal and control the household appliance 93 to work via the application. The user may also use the wireless communication device 91 to connect the household appliance 93 with the corresponding cloud server 92.

In an embodiment, the household appliance 93 which needs to acquire a service system and data of the cloud server 92 may be connected to the corresponding cloud server 92 via the wireless communication device 91, so as to realize resource sharing of the cloud server 92.

For example, the household appliance 93 which needs to acquire a service system and data of the cloud server 92 is a MideaTM air conditioner, the MideaTM air conditioner needs to acquire resources matching a sharing protocol in a MideaTM cloud server 92, and thus, the MideaTM air conditioner accesses the MideaTM cloud server via the wireless communication device 91, so as to realize resource sharing between the MideaTM cloud and the MideaTM air conditioner. In another embodiment, the MideaTM air conditioner may also access the Xiaomi cloud server via the wireless communication device 91, so as to realize resource sharing between the Xiaomi cloud and the MideaTM air conditioner.

In this embodiment, the service logic thread exchanges messages with the series data receiving and sending thread and the network data receiving and sending thread so as to control the messages received and sent by the series data receiving and sending thread and the network data receiving and sending thread. The main thread controls the series data receiving and sending thread, the network data receiving and sending thread and the service logic thread, such that threads operates collaboratively, thereby improving effects of a thread scheduling in a cloud server accessing process effectively and allowing function expansion of a hardware system of the wireless communication device. By distributing the event message to a corresponding state machine according to a mode attribute of the event message, in which the mode attribute is one of AP-Mode, STA-Mode and System; and by controlling the wireless communication device to switch a state according to the event message and a state shifting mechanism of the corresponding state machine, three types of the state machines in the wireless communication device of the household appliance operates collaboratively, thereby improving an effect of state management of the wireless communication device effectively.

In some embodiments, all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

The above-mentioned storage medium may be a read-only memory, a magnetic disc, an optical disc, etc.

What is claimed is:

1. A cloud access method based on a wireless communication device applied to a household appliance, the method comprising:
receiving, by the wireless communication device, a first type message sent by a cloud server, and acquiring, by the wireless communication device, type information of the cloud server, wherein the wireless communication device is connected to a plurality of cloud servers;
calling, by the wireless communication device, a converting protocol according to the type information of the cloud server; and
converting, by the wireless communication device, the first type message to a second type message according to the converting protocol, and sending, by the wireless communication device, the second type message to the household appliance.

2. The cloud access method according to claim 1, wherein acquiring, by the wireless communication device, type information of the cloud server further comprises:
acquiring, by the wireless communication device, connection information for a socket connected to the cloud server; and
determining, by the wireless communication device, the type information according to the connection information for the socket.

3. The cloud access method according to claim 1, further comprising:
receiving, by the wireless communication device, the second type message sent by the household appliance, acquiring, by the wireless communication device, a target address corresponding to the second type message, and determining, by the wireless communication device, the type information of the cloud server according to the target address;
calling, by the wireless communication device, the converting protocol according to the type information of the cloud server; and
converting, by the wireless communication device, the second type message to the first type message according to the converting protocol, and sending, by the wireless communication device, the first type message to the cloud server.

4. The cloud access method according to claim 1, wherein the wireless communication device comprises:
a series data receiving and sending thread, configured to communicate with the household appliance;
a network data receiving and sending thread, configured to communicate with the cloud server;
a service logic thread, configured to exchange messages with the series data receiving and sending thread and the network data receiving and sending thread, and to control the messages received and sent by the series data receiving and sending thread and the network data receiving and sending thread; and
a main thread, configured to control the series data receiving and sending thread, the network data receiving and sending thread and the service logic thread.

5. The cloud access method according to claim 4, wherein the wireless communication device further comprises:
a first series receiving data message queue, configured to receive a message sent by the series data receiving and sending thread, and to provide the message sent by the series data receiving and sending thread to the service logic thread to read;
a first series data receiving buffer, configured to receive and buffer data sent by the series data receiving and sending thread, and to provide the data sent by the series data receiving and sending thread to the service logic thread to read;
a second series receiving data message queue, configured to receive a message sent by the service logic thread, and to provide the message sent by the service logic thread to the series data receiving and sending thread to read; and
a second series data receiving buffer, configured to receive and buffer data sent by the service logic thread, and to provide the data sent by the service logic thread to the series data receiving and sending thread to read.

6. The cloud access method according to claim 5, wherein after the data of the first series data receiving buffer and the second series data receiving buffer are read, the cloud access method further comprises: deleting the data from the first series data receiving buffer and the second series data receiving buffer.

7. The cloud access method according to claim 4, wherein the wireless communication device further comprises:
a first network receiving data message queue, configured to receive messages sent by the network data receiving and sending thread, and to provide the messages sent by the network data receiving and sending thread to the service logic thread to read;
a first network data receiving buffer, configured to receive and buffer data sent by the network data receiving and sending thread, and to provide the data sent by the network data receiving and sending thread to the service logic thread to read;
a second network receiving data message queue, configured to receive messages sent by the service logic thread, and to provide the messages sent by the service logic thread to the network data receiving and sending thread to read; and
a second network data receiving buffer, configured to receive and buffer data sent by the service logic thread, and to provide the data sent by the service logic thread to the network data receiving and sending thread to read.

8. The cloud access method according to claim 7, wherein after the data of the first network data receiving buffer and the second network data receiving buffer are read, the cloud access method further comprises: deleting the data from the first network data receiving buffer and the second network data receiving buffer.

9. The cloud access method according to claim 4, wherein the wireless communication device further comprises:
an application event recalling sub-device, via which the main thread controls the service logic thread; and
an application event message queue, configured to receive an application event message generated by the service logic thread, and to provide the application event message to the main thread to read.

10. The cloud access method according to claim 4, wherein the wireless communication device further comprises:
a WIFI event recalling sub-device, configured to receive a WIFI recalling event, and to add the WIFI recalling event to the application event message queue after the WIFI recalling event is received.

11. The cloud access method according to claim 10, wherein the WIFI recalling event is generated by an application program.

12. The cloud access method according to claim 4, further comprising: managing, by the main thread, a state machine of the wireless communication device.

13. The cloud access method according to claim 12, wherein managing, by the main thread, a state machine of the wireless communication device further comprises:
receiving, by the wireless communication device, an event message;
distributing the event message to a corresponding state machine according to a mode attribute of the event message, wherein the mode attribute is one of AP-Mode, STA-Mode and System; and
controlling the wireless communication device to switch a state according to the event message and a state shifting mechanism of the corresponding state machine.

14. The cloud access method according to claim 13, wherein before the wireless communication device receives the event message, the cloud access method further comprises:
configuring the state shifting mechanism of the wireless communication device.

15. The cloud access method according to claim 14, wherein the corresponding state machine comprises an AP-Mode state machine, a STA-Mode state machine or a System state machine, and the mode attribute AP-Mode corresponds to the AP-Mode state machine, the mode attribute STA-Mode corresponds to the STA-Mode state machine, and the mode attribute System corresponds to the System state machine.

16. The cloud access method according to claim 14, wherein configuring the state shifting mechanism of the wireless communication device comprises:
integrating state attributes of the AP-Mode state machine, the STA-Mode state machine and the System state machine to configure the state shifting mechanism of the wireless communication device.

17. The cloud access method according to claim 13, wherein the state of the wireless communication device comprises an AP establishing state, an AP running state and an idle state in the AP-Mode state machine; a connecting state, a connected state and an idle state in the STA-Mode state machine; and a network non-established state, a network established state and an initialization state in the System state machine.

18. The cloud access method according to claim 17, wherein controlling the wireless communication device to switch a state according to the event message and a state shifting mechanism of the corresponding state machine comprises:
controlling, by the AP-Mode state machine, the wireless communication device to switch the state among the AP establishing state, the AP running state and the idle state according to the event message and a state shifting mechanism of the AP-Mode state machine when the mode attribute of the event message is AP-Mode;
controlling, by the STA-Mode state machine, the wireless communication device to switch the state among the connecting state, the connected state and the idle state according to the event message and a state shifting mechanism of the STA-Mode state machine when the mode attribute of the event message is STA-Mode; and
controlling, by the System state machine, the wireless communication device to switch the state among the network non-established state, the network established state and the initialization state according to the event message and a state shifting mechanism of the System state machine when the mode attribute of the event message is System.

19. The cloud access method according to claim 13, wherein the event message comprises the application event message and the WIFI recalling event message, and receiving, by the wireless communication device, an event message comprises:
receiving, by an application event message queue, the application event message generated by the service logic thread; and
receiving, by a WIFI event recalling sub-device, the WIFI recalling event message, and adding the WIFI recalling event message to the application event message queue after the WIFI recalling event message is received.

20. The cloud access method according to claim 19, further comprising:
reading the application event message and the WIFI recalling event message in the application event message queue.

21. A cloud access system based on a wireless communication device applied to a household appliance, comprising the wireless communication device, the household appliance, and a cloud server communicating with the household appliance via the wireless communication device, wherein the wireless communication device comprises:
a series data receiving and sending thread, configured to communicate with the household appliance;
a network data receiving and sending thread, configured to communicate with the cloud server;
a service logic thread, configured to exchange messages with the series data receiving and sending thread and the network data receiving and sending thread, and to control the messages received and sent by the series data receiving and sending thread and the network data receiving and sending thread;
a main thread, configured to control the series data receiving and sending thread, the network data receiving and sending thread and the service logic thread;
an application event recalling sub-device, via which the main thread controls the service logic thread;
an application event message queue, configured to receive an event message and to provide the event message to the main thread to read, wherein the event message comprises an application event message and a WIFI recalling event message;
an event distributing processing sub-device of a state machine, configured to distribute the event message to a corresponding state machine according to a mode attribute of the event message, wherein the mode attribute is one of AP-Mode, STA-Mode and System, to read the application event message and the WIFI recalling event message in the application event message queue, and to configure a state shifting mechanism of the wireless communication device; and
the state machine, configured to control the wireless communication device to switch a state according to the event message and a state shifting mechanism.

22. The cloud access system according to claim 21, wherein the wireless communication device further comprises:
a first series receiving data message queue, configured to receive a message sent by the series data receiving and sending thread, and to provide the message sent by the series data receiving and sending thread to the service logic thread to read;
a first series data receiving buffer, configured to receive and buffer data sent by the series data receiving and sending thread, and to provide the data sent by the series data receiving and sending thread to the service logic thread to read;
a second series receiving data message queue, configured to receive a message sent by the service logic thread, and to provide the message sent by the service logic thread to the series data receiving and sending thread to read; and
a second series data receiving buffer, configured to receive and buffer data sent by the service logic thread, and to provide the data sent by the service logic thread to the series data receiving and sending thread to read.

23. The cloud access system according to claim 22, wherein the data are deleted from the first series data receiving buffer and the second series data receiving buffer after the data of the first series data receiving buffer and the second series data receiving buffer are read.

24. The cloud access system according to claim 21, wherein the wireless communication device further comprises:
a first network receiving data message queue, configured to receive messages sent by the network data receiving and sending thread, and to provide the messages sent by the network data receiving and sending thread to the service logic thread to read;
a first network data receiving buffer, configured to receive and buffer data sent by the network data receiving and sending thread, and to provide the data sent by the network data receiving and sending thread to the service logic thread to read;
a second network receiving data message queue, configured to receive messages sent by the service logic thread, and to provide the messages sent by the service logic thread to the network data receiving and sending thread to read; and
a second network data receiving buffer, configured to receive and buffer data sent by the service logic thread, and to provide the data sent by the service logic thread to the network data receiving and sending thread to read.

25. The cloud access system according to claim 24, wherein the data are deleted from the first network data receiving buffer and the second network data receiving buffer after the data of the first network data receiving buffer and the second network data receiving buffer are read.

26. The cloud access system according to claim 21, wherein the wireless communication device further comprises:
a WIFI event recalling sub-device, configured to receive a WIFI recalling event, and to add the WIFI recalling event to the application event message queue after the WIFI recalling event is received.

27. The cloud access system according to claim 26, wherein the WIFI recalling event is generated by an application program.
